(19) United States
(12) Patent Application Publication
(10) Pub. No.: US 2026/0059221 A1
(43) Pub. Date: Feb. 26, 2026

(54) ADAPTIVE ACTIVE NOISE REDUCTION CONTROL

(71) Applicant: BOSE CORPORATION, Framingham, MA (US)

(72) Inventors: Lisa Fortini WATTS, Medford, MA (US); Mark R. BERGERON, Grafton, MA (US); Yishai Israel SERED, Newton, MA (US); Wayne TAMS, Waltham, MA (US); Jason Richard CONWAY, Waltham, MA (US)

(21) Appl. No.: 19/304,734

(22) Filed: Aug. 20, 2025

Related U.S. Application Data
(60) Provisional application No. 63/685,381, filed on Aug. 21, 2024.

(51) Int. Cl. H04R 1/10; H04R 3/00

(52) U.S. Cl. CPC H04R 1/1083; H04R 3/002

(57) ABSTRACT

Aspects of the present disclosure provide a wearable audio device. The wearable audio device includes one or more output transducers, a noise reduction module, and a controller. The one or more output transducers are configured to emit sound. The noise reduction module is configured to provide a level of noise reduction via the one or more output transducers. The controller is coupled to the one or more output transducers and the noise reduction module. The controller is configured to provide the level of noise reduction via the noise reduction module and the one or more output transducers based upon a level of motion measured by a motion sensor.

### CROSS-REFERENCE TO RELATED APPLICATION

This application claims the benefit of and priority to U.S. Provisional Patent Application No. 63/685,381, filed Aug. 21, 2024, which is incorporated by reference herein in its entirety.

### FIELD

Aspects of the disclosure generally relate to controlling external noise in an audio device, and more specifically to adaptive Active Noise Reduction (ANR) control to improve user experience.

### BACKGROUND

Wearable audio devices having noise cancelling capabilities have steadily increased in popularity. Modern headphones with ANR (sometimes referred to as active noise cancelling (ANC)) capabilities attenuate sounds external to the headphones to provide an immersive audio experience to the user. However, a user may want to selectively set a level of attenuation of external sounds to suit particular use cases. For instance, there may be certain situations when a user wearing the headphones with ANR turned on may want or need to set the ANR to a low level to increase situational awareness. On the other hand, there may be situations when the user may want the ANR set to a high level to attenuate external sounds. While most ANR audio devices allow the user to turn ANR on or turn off ANR, or even set a level of noise reduction, this does not provide an optimal user experience. Accordingly, methods for ANR control based on one or more external factors as well as apparatuses and systems configured to implement these methods are desired.

### SUMMARY

All examples and features mentioned herein can be combined in any technically possible manner.

Aspects of the present disclosure provide a wearable audio device. The wearable audio device includes one or more output transducers, a noise reduction module, and a controller. The one or more output transducers are configured to emit sound. The noise reduction module is configured to provide a level of noise reduction via the one or more output transducers. The controller is coupled to the one or more output transducers and the noise reduction module. The controller is configured to provide the level of noise reduction via the noise reduction module and the one or more output transducers based upon a level of motion measured by a motion sensor.

In an aspect, the controller is configured to decrease the level of noise reduction when the level of motion is above a threshold value.

In an aspect, wherein the controller is configured to increase the level of noise reduction when the level of motion is below a threshold value.

In an aspect, the wearable audio device further includes one or more acoustic sensors. The one or more acoustic sensors are configured to detect a level of environmental sound. The controller is further coupled to the one or more acoustic sensors. The controller is configured to provide the level of noise reduction via the noise reduction module and the one or more output transducers further based upon the level of environmental sound detected by the one or more acoustic sensors.

In an aspect, the controller is configured to increase the level of noise reduction when the level of environmental sound is above a threshold value.

In an aspect, wherein the controller is configured to decrease the level of noise reduction when the level of environmental sound is below a threshold value.

In an aspect, the controller is configured to provide the level of noise reduction via the noise reduction module and the one or more output transducers further based upon one or more user inputs.

In an aspect, the wearable audio device includes the motion sensor.

Aspects of the present disclosure provide a wearable audio device. The wearable audio device includes one or more acoustic sensors, a motion sensor, one or more output transducers, a noise reduction module, and a controller. The one or more acoustic sensors are configured to detect a level of environmental sound. The motion sensor is configured to detect motion. The noise reduction module is configured to provide a level of noise reduction via the one or more output transducers. The controller is coupled to the one or more output transducers and the noise reduction module. The controller is configured to determine a class of motion based upon the detected motion and to provide the level of noise reduction via the noise reduction module and the one or more output transducers based upon the class of motion.

In an aspect, the controller is configured to decrease the level of noise reduction when the class of changes from the class of motion to a second class of motion.

In an aspect, the controller is configured to increase the level of noise reduction when the class of motion changes from the class of motion to a second class of motion.

In an aspect, the controller is further coupled to the one or more acoustic sensors. The controller is configured to provide the level of noise reduction via the noise reduction module and the one or more output transducers further based upon the level of environmental sound detected by the one or more acoustic sensors.

In an aspect, the controller is configured to increase the level of noise reduction when the level of environmental sound is above a threshold value.

In an aspect, the controller is configured to decrease the level of noise reduction when the level of environmental sound is below a threshold value.

Aspects of the present disclosure provide a method for providing noise reduction via a wearable audio device. The method includes measuring a level of motion with a motion sensor and providing a level of noise reduction via one or more output transducers of the wearable audio device, wherein the level of noise reduction is based upon the level of motion detected by the motion sensor.

In an aspect, the method further includes decreasing the level of noise reduction when the level of motion is above a threshold value.

In an aspect, the method further includes increasing the level of noise reduction when the level of motion is below a threshold value.

In an aspect, the method further includes measuring a level of environmental sound with one or more acoustic sensors, wherein the level of noise reduction is based upon the level of environmental sound.

In an aspect, the method further includes decreasing the level of noise reduction when the level of environmental sound is below a threshold value.

In an aspect, the method further includes increasing the level of noise reduction when the level of environmental sound is above a threshold value.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 illustrates an example system in which aspects of the present disclosure may be practiced.

FIG. 2 illustrates an example user interface in which aspects of the present disclosure may be practiced.

FIG. 3 illustrates example operations for providing noise reduction via a wearable audio device.

FIG. 4 graphically illustrates exemplary operations for providing noise reduction via a wearable audio device.

### DETAILED DESCRIPTION

Wearable audio devices with ANR capability (e.g., ANR headphones) help users enjoy high quality music and participate in productive voice calls by attenuating sounds including noise external to the audio devices. However, ANR headphones acoustically isolate the user from the world making it difficult for the user to remain situationally aware. Thus, when the user wearing the headphones with ANR turned on desires to be situationally aware, the user either has to lower the level of noise reduction (e.g., by using a button on the headphones or on an interconnected personal device) or has to remove the headphones fully or partially from its regular listening position. This does not provide an optimal experience to the user. Additionally, removing the headphones from its listening position does not allow the user to listen to audio while simultaneously remaining situationally aware.

Aspects of the present disclosure discuss techniques for adaptively controlling a noise reduction level of a wearable audio device (e.g., temporarily increase, decrease, turn-off, or turn on the noise reduction) to enable the user to remain situationally aware or isolate themselves. Additionally, the discussed techniques allow the user to effectively remain situationally aware without having to remove the wearable audio device from its regular listening position or adjust noise reduction, such that the user can simultaneously listen to audio being played on the device transducers while remaining situationally aware.

Conventional ANR headphones generally require a user interface (UI) to change a level of noise reduction. This UI may take many forms including a button press or a gesture control. Aspects of the present disclosure provide techniques for adaptively lowering or increasing the level of noise reduction based on one or more environmental factors and/or user conditions. The one or more environmental factors and/or user conditions may include whether the user is in motion, a determined class of motion (e.g., walking, jogging, running, biking, riding or driving in a vehicle or other mode of transport) and/or an environmental sound level.

In certain aspects, the discussed techniques provide a solution to allow the user to utilize headphones with ANR without having to modify the ANR to adapt to environmental factors and/or user conditions.

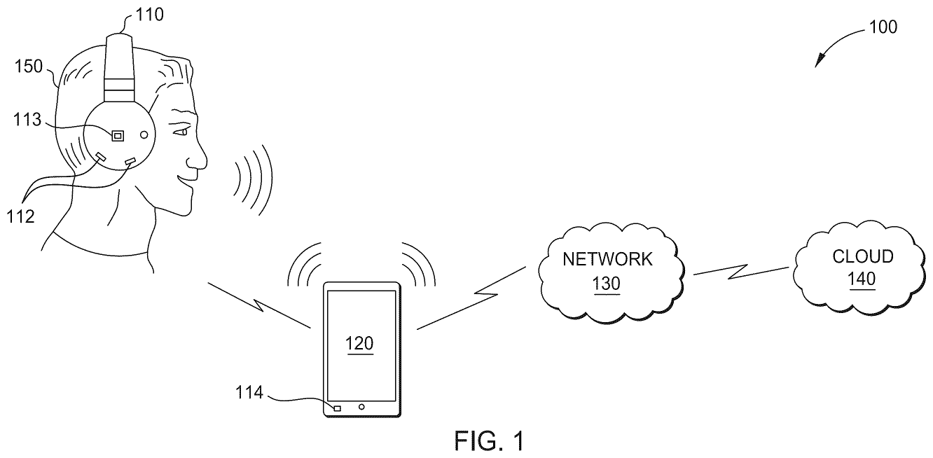

FIG. 1 illustrates an example system 100 in which aspects of the present disclosure may be practiced.

As shown, system 100 includes a pair of headphones 110 worn by a user 150. The headphones 110 are communicatively coupled to a portable user device 120. In an aspect, the headphones 110 may include one or more acoustic sensors 112 (e.g., microphones) to detect sound or a level of sound in the vicinity of the headphones 110. The headphones 110 also include one or more acoustic and/or output transducers (also known as driver or speaker) for outputting sound. The included acoustic and/or output transducer(s) may be configured to transmit (e.g., emit) audio through air and/or through bone (e.g., via bone conduction, such as through the bones of the skull). The headphones 110 may further include one or more environmental sensors 113. In one or more aspects, the environmental sensors 113 may be motion sensors configured to detect motion and/or a level of motion and/or a class of motion (e.g., one or more accelerometers, one or more gyroscopes, one or more magnetometers, etc.). In one or more aspects, the one or more acoustic sensors 112 and/or the one or more environmental sensors 113 are not located on the headphones 110 and are, rather, included in the portable user device 120 or separately wearable/useable by the user 150 (e.g., sensor 114).

The headphones 110 may further include hardware and circuitry including processor(s)/processing system and memory configured to implement one or more sound management capabilities or other capabilities including, but not limited to, noise cancelling circuitry (not shown) (collectively referred to herein as “a noise reduction module”), environment condition assessment devices/sensors and circuitry (e.g., body movement detecting devices/sensors and circuitry and geolocation circuitry), and other sound processing circuitry. According to one or more non-limiting examples, the processor(s)/processing systems and various modules devices and sensors are operable with the memory which may be in the form of computer-readable storage media (e.g., non-volatile memory). That computer-readable storage media, when executed by the environmental condition assessment devices/sensors and circuitry, facilitates the operation of the various methods described herein. In one or more aspects, the computer-readable storage media may include computer programming, such as Artificial Intelligence (“AI”) programming.

The noise reduction module is configured to reduce unwanted ambient sounds external to the headphones 110. Thus, the noise reduction module provides a level of noise reduction. The sound masking circuitry is configured to reduce distractions by playing masking sounds via the output transducers of the headphones 110. The noise reduction module may reduce unwanted ambient sounds under user control or adaptively by using ANR. In one or more aspects, the noise reduction module and, thus noise reduction, may be selectively turned on and off. In one or more aspects, the noise reduction module may be set to an ANR mode whereby the noise reduction module provides adaptive noise reduction. When noise reduction is turned off, the noise reduction module does not reduce unwanted ambient sounds external to the headphones 110. When noise reduction is turned on, the noise reduction module provides a level of noise reduction. In one or more aspects, the noise reduction module may further be configurable (adaptively or under user control) to provide different levels of noise reduction. In one or more aspects, the levels of noise reduction may be discrete levels of noise reduction, such as “high” and “low.” In one or more aspects, the levels of noise reduction may be a spectrum. As further discussed herein, the noise reduction module is also adaptable such that the provided noise reduction may be based upon one or more of environmental conditions (e.g., motion, environmental sound, and/or location), a user adjusting a level of noise reduction, and/or user-provided preferences.

The environment condition assessment devices/sensors and circuitry is configured to use devices/sensors (e.g., environmental sensors 113) for detecting an environmental condition. In one or more aspects, the environmental condition assessment devices/sensors and circuitry includes movement detecting circuitry configured to use devices/sensors such as an accelerometer, gyroscope, magnetometer, or the like (e.g., one or more environmental sensors 113) to detect whether the user 150 wearing the headphones 110 is moving (e.g., walking, jogging, running, biking, exercising, riding or driving in a vehicle or other mode of transport) or is at rest. In one or more aspects, the environmental condition assessment devices/sensors and circuitry is configured to determine a class of motion based on the level of motion detected. In one or more aspects, the classes of motion may include not moving (e.g., no motion or relatively little motion), walking, jogging, running, biking, exercising, and/or riding or driving a vehicle or some other mode of transportation.

In one or more aspects, the environmental condition assessment devices/sensors and circuitry includes geolocation circuitry configured to detect a physical location of the user wearing the headphones. For example, the geolocation circuitry includes Global Positioning System (GPS) antenna and related circuitry to determine GPS coordinates of the user. The geolocation circuitry may be used in conjunction with other aspects of the environmental condition assessment devices/sensors. According to one or more non-limiting examples, the geolocation circuitry may be used in conjunction with the environmental condition assessment devices/sensors and circuitry to detect motion and/or determine a class of motion.

In one or more aspects, the headphones 110 are wirelessly connected to the portable user device 120 using one or more wireless communication methods including but not limited to Bluetooth, Wi-Fi, Bluetooth Low Energy (BLE), other radio frequency (RF)-based techniques, or the like. In an aspect, the headphones 110 includes a transceiver that transmits and receives information via one or more antennae to exchange information with the user device 120.

In one or more aspects, the headphones 110 may be connected to the portable user device 120 using a wired connection, with or without a corresponding wireless connection. As shown, the user device 120 may be connected to a network 130 (e.g., the Internet) and may access one or more services over the network. As shown, these services may include one or more cloud services 140.

The portable user device 120 is representative of a variety of computing devices, such as mobile telephone (e.g., smart phone) or a computing tablet. In one or more aspects, the user device 120 may access a cloud server in the cloud 140 over the network 130 using a mobile web browser or a local software application or “app” executed on the user device 120. In one or more aspects, the software application or “app” is a local application that is installed and runs locally on the user device 120. In one or more aspects, a cloud server accessible on the cloud 140 includes one or more cloud applications that are run on the cloud server. The cloud application may be accessed and run by the user device 120. For example, the cloud application may generate web pages that are rendered by the mobile web browser on the user device 120. In one or more aspects, a mobile software application installed on the user device 120 and a cloud application installed on a cloud server, individually or in combination, may be used to implement the techniques for keyword recognition in accordance with aspects of the present disclosure.

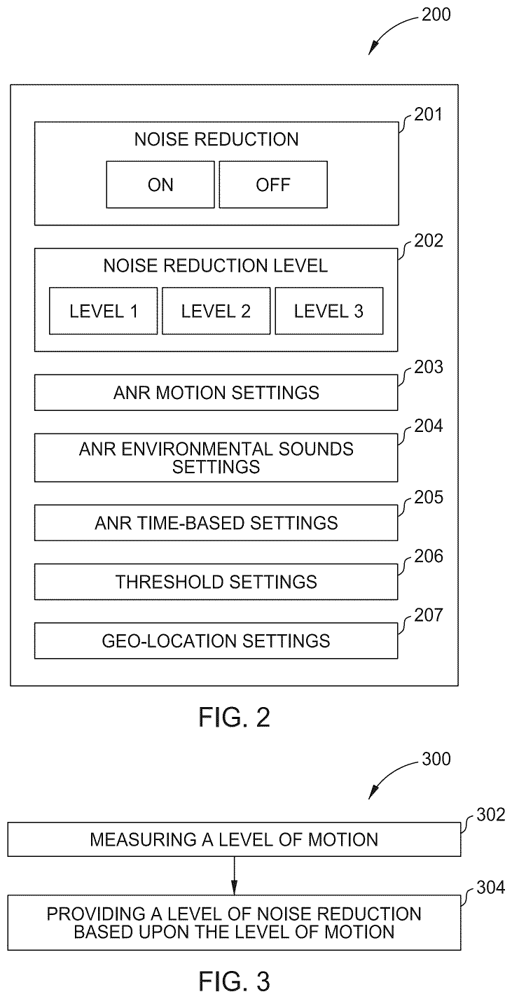

In one or more aspects, the various operations of the headphones 110 and, specifically, the noise reduction module, may include default configurations. In one or more aspects, the user 150 may configure various operations of the headphones based on user-provided settings. In one or more aspects, the software allows the user 150 to configure operations of the noise reduction module. The user 150 may configure the various operations of the headphones 110 by, for example, a user interface 200 of the portable user device 120 as shown in FIG. 2. In one or more aspects, the user 150 may turn on or off ANR via an activation setting 201 via the user interface 200. The user 150 may also configure a level of noise reduction whereby the configured level of noise reduction provides various levels of noise reduction via an noise reduction level setting 202. While illustrated as “Level 1,” “Level 2,” and “Level 3,” there may be more or less levels (e.g., one, two, three, four, five, or more levels). Furthermore the levels may instead be a spectrum. Further, the levels may be any amount of noise reduction, for instance, “Level 1,” may actually correspond to an “off” or “transparency” setting (e.g., a setting in which the headphones 110 receive environmental sound and replays that environmental sound to the user 150 thus increasing situational awareness). Further, the user-controlled configurability of the level of noise reduction may have the ability to take precedent over the adaptive control of the noise reduction as described herein (e.g., if the user selects a level, it will take precedent over the adaptive control).

In one or more aspects, the level of provided noise reduction (whether adaptive or user-configured) may also be reflected in the user interface 200. That is, whether user controlled or not, the level of noise reduction may be displayed or indicated on the user interface 200.

In one or more aspects, the user preferences may include adaptive control settings. For example, the user preferences may include setting a level of noise reduction based on a level of motion via ANR motion settings 203 (e.g., at a certain rate of motion or when in a certain class of motion, a certain level of noise reduction is provided). In one or more aspects, the user preferences may include setting a level of noise reduction based on a level of environmental sound via ANR environmental sound settings 204 (e.g., at a certain environmental sound level, a certain level of noise reduction is provided). In some aspects, the ANR motion settings 203 and ANR environmental sound settings 204 may be configurable such that a user can provide setting to level of noise reduction based on both motion and environmental sound levels (e.g., at a certain rate of motion or class of motion and a certain environmental sound level provide a certain level of noise reduction).

In one or more aspects, the user preferences may include time-based noise reduction via ANR time-based settings 205. According to one non-limiting example, a time-based noise reduction setting may include setting a time-delay whereby the noise reduction module provides a level of noise reduction (or maintains a level of noise reduction) after a user-set period of time after change in the level of motion (or change in a class of motion) or environmental sound is detected.

In one or more aspects, the user 150 may also provide thresholds of environmental sound to activate, deactivate, decrease and/or increase a level of noise reduction via threshold settings 206. According to one non-limiting example, the user 150 may provide a minimum threshold of environmental sound to activate, deactivate, decrease and/or increase a level of noise reduction. For example, the user may provide a minimum threshold of environmental sound to trigger an increase in the level of noise reduction provided by the noise reduction module. In one or more aspects there may be more than one threshold. According to one non-limiting example, there may be a first threshold to turn on, activate, and/or increase a level of noise reduction and a second threshold to turn off, deactivate, and/or decrease the level of noise reduction. In one or more aspects, the first threshold may be higher than the second threshold.

In one or more aspects, the user 150 may also provide thresholds of motion or classes of motion to activate, deactivate, decrease and/or increase a level of noise reduction. According to one non-limiting example, the user 150 may provide a class of motion to activate, deactivate, decrease and/or increase a level of noise reduction. For example, a user 150 may provide a level of noise reduction for a class of motion indicating that the user is walking.

According to another non-limiting example, the user 150 may provide a threshold of motion to activate, deactivate, decrease and/or increase a level of noise reduction. In one or more of such aspects there may be more than one threshold. According to one non-limiting example, there may be a first threshold to turn on, activate, and/or increase a level of noise reduction and a second threshold to turn off, deactivate, and/or decrease the level of noise reduction. In one or more aspects, the first threshold may be higher than the second threshold.

In one or more aspects, a user 150 may provide geo-location based ANR settings via geolocation settings 207. According to one non-limiting example, the user 150 may dictate a level of noise reduction based on a determined location of the user 150.

As noted above, there may be default configurations and settings. Accordingly, one or more of the above configurations and settings may be set to a default without requiring user input.

It may be noted that although certain aspects of the present disclosure discuss adaptive ANR control in the context of headphones 110 for exemplary purposes, any wearable audio device with similar capabilities may be interchangeably used in these aspects. For instance, a wearable audio device usable with techniques discussed herein may include over-the-ear headphones, audio eyeglasses or frames, in-ear buds, around-ear audio devices, open-ear audio devices (such as shoulder-worn or other body-worn audio devices) or the like.

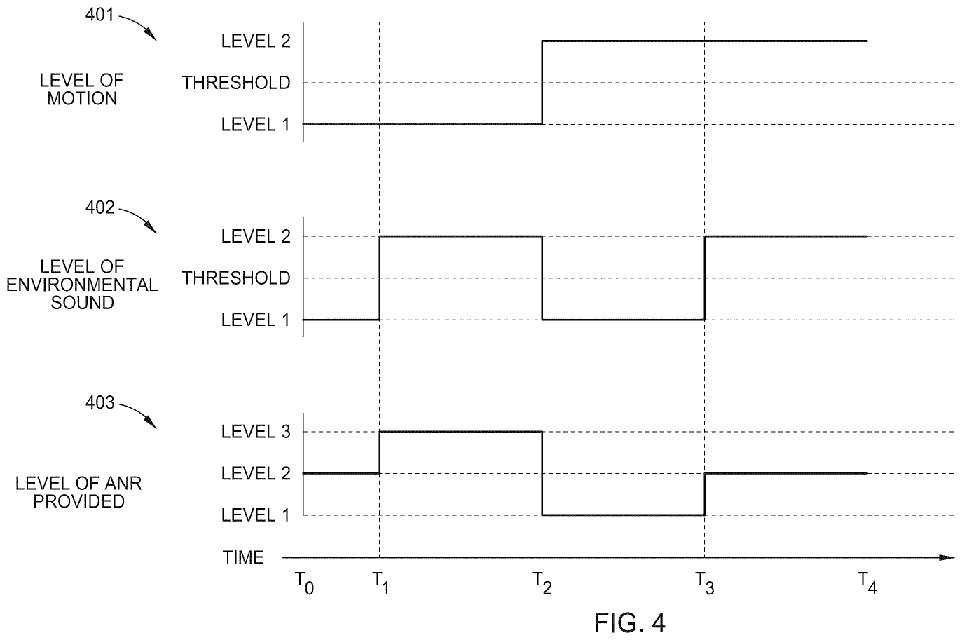

FIG. 3 illustrates example operations 300 performable by a wearable audio device (e.g., headphones 110 as shown in FIG. 1) worn by a user (e.g., user 150) and/or performable by a device (such as portable device 120) for adaptively controlling ANR, in accordance with certain aspects of the present disclosure.

Operations 300 begin, at operation 302, by detecting motion from a user wearing the wearable audio device, wherein the audio output device has active noise reduction turned on. The motion may be detected with one or more motion sensors (such as environmental sensors 113 of FIG. 1). The one or more motion sensors may be part of the wearable audio device. In one or more aspects, the one or more sensors are otherwise able to detect motion of the user but may not be coupled to, or a component of the wearable audio device. According to one non-limiting example, the one or more sensors are a component of, or communicatively coupled to a portable device (such as portable device 120) utilized by the user that is communicatively coupled to the wearable audio device. In one or more aspects, operations 300 further include determining that the motion from the user is above a threshold. The threshold may be indicative of the user moving (e.g., if the motion is above the threshold, the user is in motion and if the motion is below the threshold, the user is at rest). The threshold may further be a certain rate of motion (e.g., if the user is moving at a certain rate). Thus, operations 300 may further include determining whether the level of motion is indicative of the user being in motion and/or determining whether the detected motion indicates the user is moving at a certain rate.

At operation 304, in response to measuring the motion, a level of noise reduction is provided based, at least, on the detected motion. In one or more aspects, the level of noise reduction is decreased when the motion is over a threshold (e.g., when the motion is indicative that the user is in motion and/or indicative the user is moving at a certain rate). In one or more aspects, the level of noise reduction is increased when the motion is below a threshold (e.g., when the motion is indicative that the user is at rest). That is, when it is determined that the user is in motion (or moving at a certain rate), the level of noise reduction may be decreased to increase the user's situational awareness and, when it is determined that the user is not in motion (or is at rest), the level of noise reduction may be increased to a level to allow the user to isolate themselves. In other words, the level of noise reduction may be adaptive based on the detected motion to appropriately balance situational awareness and isolation.

According to one non-limiting example, a user may be running, jogging, walking, or in transit while utilizing headphones equipped with ANR. While the user is running, jogging, walking, or in transit the user may require more situational awareness. Accordingly, because the user is moving, the level of provided noise reduction may be reduced to provide more situational awareness. In one or more aspects, if the measured motion is above a threshold indicating that the user is moving at a faster rate (e.g., running, or even more, in a vehicle), the level of provided noise reduction may be reduced further to provide more situational awareness. However, if the level of motion indicates that the user is at rest, the level of provided noise reduction may be increased as the level of required situational awareness may be less. In sum, the level of provided noise reduction may be adapted, at least in part, based on the motion of the user indicating the user requires more or less situational awareness.

In one or more aspects, operations 300 may further include determining a class of motion based on the detected motion. According to one or more non-limiting examples, the class of motion may be that user is at rest (or moving relatively little), walking, jogging, running, biking, exercising, or travelling in a vehicle or other mode of transport. According to one or more non-limiting examples, the classes may be further broken down into sub-classes such as walking faster and walking slower. Thus, based, at least in part, on the detected motion, it is determined whether the user is at rest (or moving relatively little), walking, jogging, running, biking, exercising, or travelling in a vehicle or other mode of transport. Further, based on the determination of class of motion, operation 304 may include providing a level of noise reduction based, at least, upon the class of motion. In one or aspects, each class of motion may have an associated level of noise reduction (e.g. by default configuration or user-controlled configuration). In one or more aspects, controlling the level of noise reduction is based upon the change in class of motion rather than the class of motion itself.

In one or more aspects, the level of noise reduction is decreased when it is determined that the user's movement falls within a class of motion. In one or more aspects, the level of noise reduction is increased when it is determined that the user's movement falls within a class of motion. In one or more aspects, the level of noise reduction is increased when it is determined that the user's movement falls within a different class of motion. In one or more aspects, the level of noise reduction is decreased when it is determined that the user's movement falls within a different class of motion. According to one or more non-limiting examples, as the user moves into a different class of motion from the class the user was previously in, the user may require more situational awareness. Accordingly, because the user may require more situational awareness, the level of provided noise reduction may be reduced to provide more situational awareness. According to one or more non-limiting examples, as the user moves into a different class of motion from the class the user was previously in, the user may require less situational awareness. Accordingly, because the user may require less situational awareness, the level of provided noise reduction may be increased to provide less situational awareness and more isolation. In sum, the level of provided noise reduction may be adapted, at least in part, based on the class of motion.

In one or more aspects, operations 300 may further include measuring a level of environmental sound with one or more acoustic sensors. The one or more acoustic sensors may be a part of the wearable audio device (e.g., acoustic sensors 112). In one or more aspects, the acoustic sensors are otherwise able to detect environmental sound, but may not be coupled to or a component of the wearable audio device (e.g., sensor 114). According to one non-limiting example, the one or more sensors are a component of, or communicatively coupled to a portable device (such as portable device 120) utilized by the user that is communicatively coupled to the wearable audio device.

In one or more aspects, the level of noise reduction may be provided based on the level of motion and the level of environmental sound. In one or more aspects, if the level of environmental sound is above a threshold, the level of noise reduction may be increased and, if the level of environmental sound is below a threshold, the level of noise reduction may be decreased. In other words, the level of noise reduction may be adaptive based on the level of environmental sound to appropriately reduce and/or mask environmental sound based on the measured level of environmental sound. That is, the level of noise reduction may increase as the level of environmental sound increases and the level of noise reduction may decrease as the level of environmental sound decreases.

In one or more aspects, operations 300 may further include providing the level of noise reduction based on one or more of the user-provided settings as described above with respect to FIG. 2. According to one non-limiting example, the above-mentioned thresholds may be user-provided thresholds (e.g., via threshold settings 206). According to one non-limiting example, the provided level may be based on the user-provided settings (e.g., based on one or more of the settings of exemplary user interface 200).

FIG. 4 graphically illustrates one or more aspects of exemplary operations 300. Chart 401 graphically illustrates a level of motion at a given time Tₓ. While illustrated as “Level 1” and “Level 2,” it should be understood that the levels may correspond to any amounts of motion or a lack thereof. The illustrated levels are merely meant to illustrate a relationship between the various levels and classes. According to one non-limiting example, Level 1 may indicate the user is at rest, the threshold may be some threshold level of motion, and Level 3 may be indicative of the user moving. In one or more aspects, the threshold may be some threshold set by a user as described above or may be a default setting.

It also should be understood that the “Levels” could include classes of motion (e.g. “Level 1” is a first class of motion, “Level 2” is a second class of motion, and “Threshold” indicates the point at which a user's motion changes from the first class to the second class)

Chart 402 graphically illustrates a level of environmental sound at a given time Tₓ. While illustrated as “Level 1” and “Level 2,” it should be understood that the levels may correspond to any amounts of environmental sound or a lack thereof. The illustrated levels are merely meant to illustrate a relationship between the various levels (e.g., the higher the level, the more environmental sound). According to one non-limiting example, Level 1 may indicate the user is in a relatively quiet environment (e.g., 100 dB or lower, such as, 75 dB or lower, 65 dB or lower, or 50 dB or lower), the threshold may be some threshold level of environmental sound, and Level 3 may be indicative of a relatively loud environment (e.g., 50 dB or higher, such as 65 dB or higher, 75 dB or higher, or 100 dB or higher). In one or more aspects, the threshold may be some threshold set by a user as described above.

Chart 403 graphically illustrates a level of noise reduction provided at a given time Tₓ based upon the measured motion and environmental sound. While illustrated as “Level 1,” “Level 2,” and “Level 3” it should be understood that the levels may correspond to any amounts of provided noise reduction or a lack thereof. The illustrated levels are merely meant to illustrate a relationship between the various levels (e.g., the higher the level, the more noise reduction is provided). According to one non-limiting example, Level 1 may be a low level of noise reduction, Level 2 may be an intermediate level of noise reduction, and Level 3 may be a high level of noise reduction. In one or more aspects, Level 1 may also represent a lack of noise reduction or a “transparency” setting.

Between times T₀ and T₁ the level of motion is below a motion threshold (e.g., is at Level 1) and the level of environmental sound is below a sound threshold (e.g., is at Level 1). According to one non-limiting example, the user may be at rest in a relatively quiet environment. Accordingly, a user may require less situational awareness because the user is at rest. Therefore, noise reduction is provided at Level 2.

At time T₁ the level of motion remains below the motion threshold or within a first class of motion) and the level of environmental sound has increased to be above the sound threshold (e.g., is at Level 2). According to one non-limiting example, the user may be at rest in a relatively loud environment. Accordingly, between times T₁ and T₂, a user may require less situational awareness because the user is at rest and may require more noise reduction to counteract the relatively loud environment. Therefore, noise reduction is provided at Level 3. The provided level of noise reduction (e.g., Level 3) may be a level of noise reduction to provide isolation from the relatively loud environment.

At time T₂ the level of motion has increased above the motion threshold (or has changed to a different motion class) and the level of environmental sound has decreased to be below the sound threshold (e.g., is at Level 1). According to one non-limiting example, the user may be in motion (e.g., running, jogging, in transport, etc.) in a relatively quiet environment. Accordingly, between times T₂ and T₃, a user may require more situational awareness because the user is in motion (or has changed to a different motion class). Further, a user may require less noise reduction because of the relatively quiet environment. Accordingly, the noise reduction is reduced to provide less noise reduction (e.g., Level 1) to provide situational awareness and because the environment is relatively quiet. The provided level of noise reduction (e.g., Level 1) may be a level of noise reduction to provide some isolation from the relatively quiet environment while still providing situational awareness, may be a lack of noise reduction, or may be a “transparency” mode.

At time T₃ the level of motion remains above the motion threshold (or in the second motion class) and the level of environmental sound has increased to be above the sound threshold (e.g., is at Level 2). According to one non-limiting example, the user may be in motion (e.g., running, jogging, in transport, etc.) in a relatively loud environment. Accordingly, between times T₃ and T₄, a user may require more situational awareness because the user is in motion. Further, a user may require more noise reduction because of the relatively loud environment. Accordingly, the noise reduction is increased to provide a level of noise reduction (e.g., Level 2) to maintain situational awareness while providing some level of noise reduction to counteract the relatively loud environment. The provided level of noise reduction (e.g., Level 2) may be a level of noise reduction to provide isolation from the relatively loud environment while still providing situational awareness.

While charts 401, 402, and 403 are illustrated as step-functions, it should be understood that the levels of motion and levels of environmental sound may include ramp times, peaks, valleys, and other variations in levels. Accordingly, it should be understood that the level of noise reduction provided may mirror the ramp times, peaks, valleys, and other variations in levels of motion and environmental sound.

It may be noted that the processing related to the ANR control as discussed in aspects of the present disclosure may be performed natively in the headphones, by the user device or a combination thereof.

It can be noted that, descriptions of aspects of the present disclosure are presented above for purposes of illustration, but aspects of the present disclosure are not intended to be limited to any of the disclosed aspects. Many modifications and variations will be apparent to those of ordinary skill in the art without departing from the scope and spirit of the described aspects.

In the preceding, reference is made to aspects presented in this disclosure. However, the scope of the present disclosure is not limited to specific described aspects. Aspects of the present disclosure can take the form of an entirely hardware aspect, an entirely software aspect (including firmware, resident software, micro-code, etc.) or an aspect combining software and hardware aspects that can all generally be referred to herein as a “component,” “circuit,” “module” or “system.” Furthermore, aspects of the present disclosure can take the form of a computer program product embodied in one or more computer readable medium(s) having computer readable program code embodied thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium can be any tangible medium that can contain, or store a program.

The flowchart and block diagrams in the Figures illustrate the architecture, functionality and operation of possible implementations of systems, methods and computer program products according to various aspects. In this regard, each block in the flowchart or block diagrams can represent a module, segment or portion of code, which comprises one or more executable instructions for implementing the specified logical function(s). In some alternative implementations the functions noted in the block can occur out of the order noted in the figures. For example, two blocks shown in succession can, in fact, be executed substantially concurrently, or the blocks can sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

What is claimed is:

1. A wearable audio device, comprising:
one or more output transducers configured to emit sound;
a noise reduction module configured to provide a level of noise reduction via the one or more output transducers; and
a controller coupled to the one or more output transducers and the noise reduction module, wherein the controller is configured to provide the level of noise reduction via the noise reduction module and the one or more output transducers based upon a level of motion measured by a motion sensor.

2. The wearable audio device of claim 1, wherein the controller is configured to decrease the level of noise reduction when the level of motion is above a threshold value.

3. The wearable audio device of claim 1, wherein the controller is configured to increase the level of noise reduction when the level of motion is below a threshold value.

4. The wearable audio device of claim 1, further comprising one or more acoustic sensors configured to detect a level of environmental sound, wherein the controller is further coupled to the one or more acoustic sensors, and wherein the controller is configured to provide the level of noise reduction via the noise reduction module and the one or more output transducers further based upon the level of environmental sound detected by the one or more acoustic sensors.

5. The wearable audio device of claim 4, wherein the controller is configured to increase the level of noise reduction when the level of environmental sound is above a threshold value.

6. The wearable audio device of claim 4, wherein the controller is configured to decrease the level of noise reduction when the level of environmental sound is below a threshold value.

7. The wearable audio device of claim 1, wherein the controller is configured to provide the level of noise reduction via the noise reduction module and the one or more output transducers further based upon one or more user inputs.

8. The wearable audio device of claim 1, wherein the wearable audio device includes the motion sensor.

9. A wearable audio device, comprising:
one or more acoustic sensors configured to detect a level of environmental sound;
a motion sensor configured to detect motion;
one or more output transducers configured to emit sound;
a noise reduction module configured to provide a level of noise reduction via the one or more output transducers; and
a controller coupled to the one or more output transducers and the noise reduction module, wherein the controller is configured to:
determine a class of motion based upon the detected motion; and
to provide the level of noise reduction via the noise reduction module and the one or more output transducers based upon the class of motion.

10. The wearable audio device of claim 9, wherein the controller is configured to decrease the level of noise reduction when the class of changes from the class of motion to a second class of motion.

11. The wearable audio device of claim 9, wherein the controller is configured to increase the level of noise reduction when the class of motion changes from the class of motion to a second class of motion.

12. The wearable audio device of claim 9, wherein the controller is further coupled to the one or more acoustic sensors, and wherein the controller is configured to provide the level of noise reduction via the noise reduction module and the one or more output transducers further based upon the level of environmental sound detected by the one or more acoustic sensors.

13. The wearable audio device of claim 12, wherein the controller is configured to increase the level of noise reduction when the level of environmental sound is above a threshold value.

14. The wearable audio device of claim 12, wherein the controller is configured to decrease the level of noise reduction when the level of environmental sound is below a threshold value.

15. A method for providing noise reduction via a wearable audio device, comprising:
measuring a level of motion with a motion sensor; and
providing a level of noise reduction via one or more output transducers of the wearable audio device, wherein the level of noise reduction is based upon the level of motion detected by the motion sensor.

16. The method of claim 15, further comprising:
decreasing the level of noise reduction when the level of motion is above a threshold value.

17. The method of claim 15, further comprising:
increasing the level of noise reduction when the level of motion is below a threshold value.

18. The method of claim 15, further comprising:
measuring a level of environmental sound with one or more acoustic sensors, wherein the level of noise reduction is based upon the level of environmental sound.

19. The method of claim 18, further comprising:
decreasing the level of noise reduction when the level of environmental sound is below a threshold value.

20. The method of claim 18, further comprising:
increasing the level of noise reduction when the level of environmental sound is above a threshold value.
